(19) United States
(12) Patent Application Publication
(10) Pub. No.: US 2024/0126073 A1
(43) Pub. Date: Apr. 18, 2024

(54) METHOD AND SYSTEM FOR PASSIVE RANGE IMAGING

(71) Applicant: Technion Research & Development Foundation Limited, Haifa (IL)

(72) Inventors: Yoav SHECHTMAN, Haifa (IL); Nadav OPATOVSKI, Haifa (IL)

(73) Assignee: Technion Research & Development Foundation Limited, Haifa (IL)

(21) Appl. No.: 18/376,466

(22) Filed: Oct. 4, 2023

Related U.S. Application Data
(60) Provisional application No. 63/412,897, filed on Oct. 4, 2022.

(51) Int. Cl. G02B 27/00; G06T 5/20; G06T 5/73

(52) U.S. Cl. CPC G02B 27/0025; G06T 5/20; G06T 5/73

(57) ABSTRACT

In a range imaging system, a passive optical system has a set of lenses and an optical mask that varies a point spread function of the set of lenses so as to encode in an optical field arriving from a scene range information for objects in the scene that are at least X meters from the mask, where X is at least 10. A digital light sensor receives the optical field, and an image processor processes signals receive signals from the sensor to decode the range information.

### RELATED APPLICATIONS

This application claims the benefit of priority under 35 USC § 119(e) of U.S. Provisional Patent Application No. 63/412,897 filed on Oct. 4, 2022, the contents of which are all incorporated by reference as if fully set forth herein in their entirety.

### FIELD AND BACKGROUND OF THE INVENTION

The present invention, in some embodiments thereof, relates to imaging and, more particularly, but not exclusively, to a method and a system for passive range imaging.

Range imaging, also known is useful in various technological applications across different industries. Traditionally, this field has witnessed the utilization of various techniques to estimate distances, object shapes, and spatial configurations.

Time-of-flight (ToF) range imaging systems operate by emitting a light pulse and measuring the time it takes for the light to travel to a scene and return to the sensor. This information is used to determine the distance. Structured light, on the other hand, projects patterns of light onto the scene and measures deformations in these patterns to calculate depth. Other techniques, such as stereo vision, LIDAR (Light Detection and Ranging), and acoustic-based range imaging, have also been explored.

The above are examples of active range imaging techniques, wherein there is an emission of energy from the imaging system to the scene. Also known are passive range imaging techniques which rely on capturing ambient or naturally occurring energy, such as ambient light, without actively emitting energy. In these techniques the measurement is based on analyzing the characteristics of the received energy. Traditional methods for passive range estimations at short distances include focus/defocus (2), and triangulation by stereo imaging (3). Another approach for passive distance estimation is wavefront shaping, specifically, point-spread-function (PSF) engineering (9-11). In this approach, a modified PSF contains information on the curvature of the incoming wavefront, encoding the distance of the object.

### SUMMARY OF THE INVENTION

According to some embodiments of the invention there is provided a range imaging system. The range imaging system comprises: a passive optical system having a set of lenses and an optical mask constituted to vary a point spread function (PSF) of the set of lenses so as to encode in an optical field arriving from a scene range information for objects in the scene that are at least X meters from the mask, where X is at least 10. The system also comprises a digital light sensor arranged to receive the optical field, and an image processor, configured to processes signals receive signals from the sensor to decode the range information.

According to some embodiments of the invention the passive optical system comprises a telescope.

According to some embodiments of the invention the passive optical system comprises a optics of a camera.

According to some embodiments of the invention the processor is configured to process a stream of signals corresponding to a video image of said scene.

According to some embodiments of the invention the processor is configured to process signals corresponding to a still image of said scene.

According to some embodiments of the invention the set of lenses forms a 2-f optical arrangement, and the optical mask is at a back focal plane thereof.

According to some embodiments of the invention the set of lenses forms a 2-f optical arrangement, and the optical mask is at a Fourier plane thereof.

According to some embodiments of the invention the passive optical system is characterized by an aperture diameter of at least 50 mm, more preferably at least 60 mm, more preferably at least 70 mm, more preferably at least 90 mm, more preferably at least 100 mm.

According to some embodiments of the invention the X is at least 100, more preferably at least 200, more preferably at least 400, more preferably at least 800, more preferably at least 1600, more preferably at least 3200, more preferably at least 6400.

According to some embodiments of the invention the optical mask is configured to vary the PSF into a double-helix PSF.

According to some embodiments of the invention the sensor is a thermography sensor.

According to some embodiments of the invention the image processor is configured to apply a cepstrum transform to the signals. According to some embodiments of the invention the cepstrum transform is a complex cepstrum transform.

According to some embodiments of the invention the image processor is configured to calculate an orientation of a lobe of the varied PSF, wherein the decoding is based on the orientation.

According to some embodiments of the invention the image processor is configured to calculate a center-of-mass of the lobe, wherein the calculation of the orientation is based on the center-of-mass.

According to some embodiments of the invention the decoding is by a lookup table or a calibration curve mapping the orientation to the range information.

According to some embodiments of the invention the image processor is configured to decode the range information by applying machine learning.

According to some embodiments of the invention the image processor is configured to apply a cepstrum transform to the signals and to feed the cepstrum transform into a machine learning procedure trained to output the range information.

According to some embodiments of the invention the image processor is configured to apply an object recognition image processing to identify an object in the scene, wherein the decoding is executed for the identified object.

According to some embodiments of the invention the optical mask is a phase mask.

According to some embodiments of the invention the optical mask is an amplitude mask.

According to some embodiments of the invention the optical mask is a phase-amplitude mask.

According to some embodiments of the invention the optical mask is a 3D-printed optical mask.

According to an aspect of some embodiments of the present invention there is provided a method of measuring a range to an object. The method comprises: capturing image data of the object by digital light sensor arranged to receive an optical field from a passive optical system as delineated above and optionally and preferably as further detailed below, and processing the image data signals to decode the range information.

According to some embodiments of the invention the object is static.

According to some embodiments of the invention the object is a moving object.

According to some embodiments of the invention the object is a vehicle.

According to some embodiments of the invention the vehicle is selected from the group consisting of an aerial vehicle (e.g., a drone, an aircraft, a jet airplane, a helicopter, an unmanned aerial vehicle, a passenger aircraft, a cargo aircraft), a ground vehicle (e.g., an automobile, a motorcycle, a truck, a tank, a train, a bus, an unmanned ground vehicle), an aqueous vehicle (e.g., a boat, a raft, a battleship), an amphibious vehicle and a semi-amphibious vehicle.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE SEVERAL VIEWS OF THE DRAWINGS

The patent or application file contains at least one drawing executed in color. Copies of this patent or patent application publication with color drawing(s) will be provided by the Office upon request and payment of the necessary fee.

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIGS. 1A-D show optical setup and analysis pipeline, employed in experiments performed according to some embodiments of the present invention. FIG. 1A illustrates an optical setup, comprising a telescope and a subsequent 4-f system. WF denotes an incoming light wavefront, T denotes a telescope, BP denotes a bandpass filter, L denotes a lens, PM denotes a phase mask. FIG. 1B shows simulated PSFs of the optical system, at different distances. FIG. 1C shows analysis pipeline of distance estimation: in (1) the Ceptrum transform (CT) is applied on an ROI in the image, in (2) the cepstrum is filtered to improve lobe detection, in (3) a window is chosen around the maximal-value pixel, and Center of Mass (CoM) localization is performed inside, and in (4) the angle of the CoM is obtained, and used to estimate distance, based on a calibration curve (details in Materials and Methods). FIG. 1D is a schematic illustration of the alternative depth-decoding process by a neural network.

FIGS. 2A-F show results of distance estimation of a moving car and a moving drone, as obtained in experiments performed according to some embodiments of the present invention. Each of FIGS. 2A-C shows example frames (right), where the analyzed ROI is highlighted in a square marked by a white arrow, the ROI (top left), and a close up of the cepstrum of the ROI (bottom left), where the center is darkened for improved visibility, and where the angle obtained from CoM localization of the lobe is expressed by a line from the center. FIG. 2D shows PSF-based estimations compared against a curve generated by applying priors on the data. FIG. 2E shows snapshots of a flying drone at different distances. FIG. 2F shows the results of drone distance estimation, where Ground Truth (GT) is obtained from the drone's built-in GPS (assumed precision of about 5 m), and where the standard deviation of distance estimation is based on estimation from 100 individual frames.

FIGS. 3A-F show distance estimation of static scenes, as obtained in experiments performed according to some embodiments of the present invention. FIG. 3A is a color image of the view containing the targets used for distance estimation, where the ROI of each target is marked by a square. FIG. 3B shows results of distance estimation per object, compared to the GT values from the rangefinder or GPS. The error bars indicate the standard deviation in distance estimation, from 100 frames. FIG. 3C shows zoom-ins on the ROIs, and their cepstrums, where the left images are the ROI of each object as acquired by the PSF-engineering system (the first frame is shown), the right images show the average cepstrum of 100 frames, where the estimated lobe-angle obtained per frame is shown in blue and the excluded outliers are marked by yellow lines. Note that the averaged cepstrum is symmetric, so that the area covered by the lines is mirrored around the center of the cepstrum. FIG. 3D shows an example scene acquired according to some embodiments of the present invention in dusty atmosphere. FIG. 3E shows the image of the scene as acquired by the PSF-engineering setup, where ROI zoom-ins and their complementary cepstrums are shown to the right. FIG. 3F shows a depth-map of the scene obtained by patch-based cepstrum analysis. The pixels of the depth map are smaller than the complement ROI sizes due to the partial overlap of ROIs.

FIGS. 4A-D show turbulence effect on precision as obtained in experiments performed according to some embodiments of the present invention. FIG. 4A shows the effect of turbulence on the PSF. PSFs from a point source acquired under mild (light blue, top row) and intense (red, bottom row) turbulence conditions (data from 20:00 and 12:00, respectively). The first 3 frames of each data were colored and overlaid to emphasize the effect. The average of all 1,000 frames is shown in grayscale at the rightmost image. FIG. 4B is a density-plot of the angle-estimation results from 1,000 frames at different times of the day (top), and the standard deviation σ_{θ}of the estimated angle, per acquisition (bottom). FIG. 4C shows the expected range of the system due to atmospheric turbulence (AT), at different turbulence conditions (defined by σ_{θ}). FIG. 4D shows normalized temporal correlations of angle-estimation, at the different times of the day (legend numbers denote acquisition times).

FIGS. 5A-C demonstrate correction of the imaging model, as obtained in experiments performed according to some embodiments of the present invention. FIG. 5A shows a designed phase mask and corresponding simulated PSFs at 12 object distances shown at left top of each image with the unit of meter. FIG. 5B shows experimental PSFs, each of which is one of the 100 frames. FIG. 5C shows the retrieved phase and the corresponding simulated PSFs. The upper right is a 3D visualization of the PSFs from 200 m to 1,650 m. The red arrows show angle correction.

FIGS. 6A-B show apparent wheel-separation curve from the data, for GT estimation, as obtained in experiments performed according to some embodiments of the present invention. FIG. 6A is an image of concatenated cross sections (transposed), with black lines marking the wheel edges, as obtained according to some embodiments of the present invention by thresholding. FIG. 6B shows result of analyzing the data from FIG. 6A, showing individual wheel positions, raw distance and the curve generated after outlier exclusion and smoothing.

FIGS. 7A-B show an example of apparent wheel-separation curve simulation, with an arbitrary PSF, as obtained in experiments performed according to some embodiments of the present invention. FIG. 7A shows an image of concatenated cross sections (transposed), with black lines marking the wheel edges, as obtained according to some embodiments of the present invention by thresholding. FIG. 7B shows analysis result. The corrected wheel separation (denoted bootstrap in FIG. 7B) shows no significant bias due to the PSF, regardless of PSF angle.

FIG. 8 shows calibration curve fit for the static scenes shown in FIGS. 3A-F.

FIG. 9 is a schematic illustration of a range imaging system, according to some embodiments of the present invention.

FIG. 10 is flowchart diagram of a method suitable for measuring a range to an object according to various exemplary embodiments of the present invention.

### DESCRIPTION OF SPECIFIC EMBODIMENTS OF THE INVENTION

The present invention, in some embodiments thereof, relates to imaging and, more particularly, but not exclusively, to a method and a system for passive range imaging.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

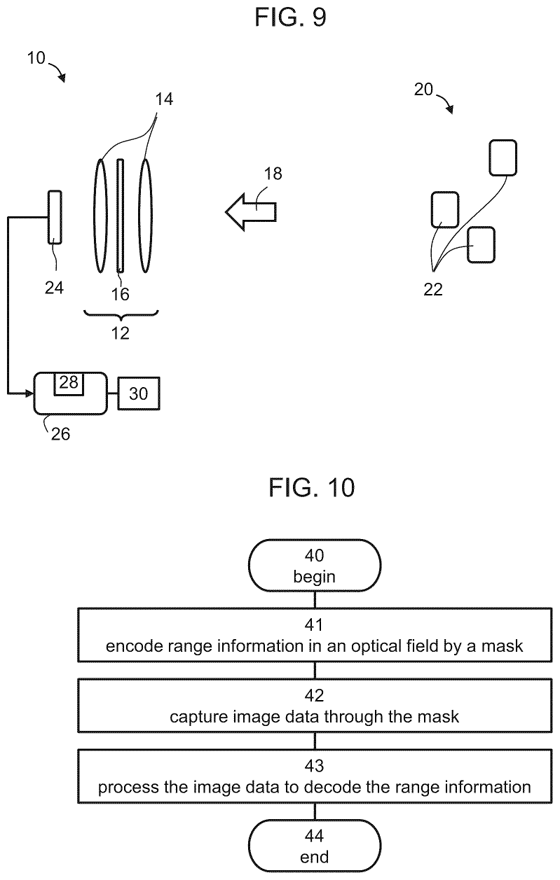

Referring now to the drawings, FIG. 9 is a schematic illustration of a range imaging system 10, according to some embodiments of the present invention. System 10 comprises a passive optical system 12 having a set 14 of lenses and an optical mask 16 constituted to vary a point spread function (PSF) of the set 14 of lenses so as to encode in an optical field 18 arriving from a scene 20 range information for objects 22 in scene 20.

As used herein “passive optical system” refers to an optical system that is incapable of generating an optical wave. Thus, passive optical system 12 is devoid of any light source.

The optical field 18 is therefore a reflection and/or transmission and/or refraction of ambient light by the object 22.

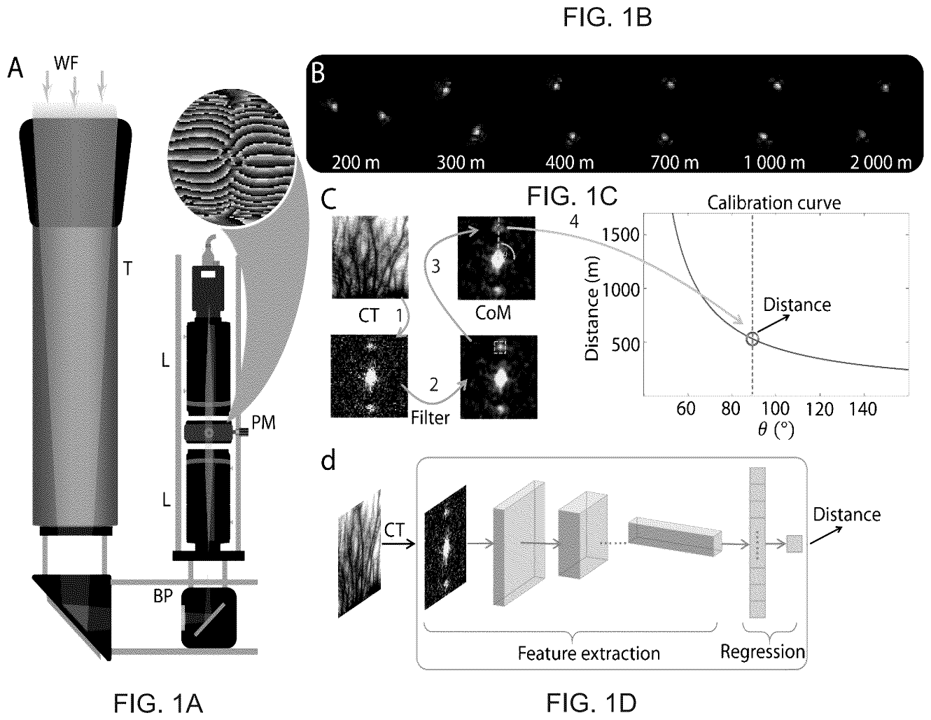

As used herein, “point spread function” is a measure that characterizes the blurring function of a lens or a set of lenses. The point spread function describes a pattern of the light that is produced when a point source of light is transmitted through the lens or a set of lenses. Typically, the point spread function is expressed as a mathematical function, but in some embodiments of the present invention the point spread function can be represented graphically. Representative examples of point spread functions are shown in FIGS. 1B, 4A, 5A-C.

Preferably, objects 22 are at least X meters from mask 16, where X is at least 10, more preferably at least 100, more preferably at least 200, more preferably at least 400, more preferably at least 800, more preferably at least 1600, more preferably at least 3200, more preferably at least 6400. This is advantageous over conventional passive range imaging system which can only estimate ranges distances that are mush shorter than 10 meters.

In some embodiments of the present invention passive optical system 12 is characterized by an aperture diameter of at least 50 mm, more preferably at least 60 mm, more preferably at least 70 mm, more preferably at least 90 mm, more preferably at least 100 mm. This is advantageous over conventional passive range imaging system which employ aperture diameter of mush less than 50 mm, and therefore suffer from insufficient resolution and are less suitable for imaging at low light conditions.

Set 14 of lenses can arranged in any arrangement that allows imaging scene 20 from a distance of at least X meters. For example, set 14 can be arranged in a 2-f optical arrangement, a 4-f optical arrangement, or any other arrangement of lenses that allows physical access to the Fourier plane. In any arrangement, the mask 16 can be placed at a back focal plane of set 14 or at a Fourier plane thereof. Also contemplated, are embodiments in which mask 16 is placed directly on the arrangement of lenses. The advantage of this embodiment is that it does not require additional optics.

Optical mask 16 can be a phase mask or an amplitude mask.

As used herein “a phase mask” refers to an optical mask that alters the phase of optical field passing through it, without substantially (e.g., within a tolerance of 10%) changing its amplitude.

As used herein “an amplitude mask” refers to an optical mask that alters the amplitude of optical field passing through it, without substantially (e.g., within a tolerance of 10%) changing its phase.

Alternatively optical mask 16 can be a phase-amplitude mask, which alters the both the amplitude and phase of the optical field passing through it.

Optical mask 16 can be manufactured by any technique known in the art, including, without limitation, photolithography, imprint lithography, electron beam lithography, three-dimensional printing and the like.

Optical mask 16 is configured to vary the PSF of set 14 into a predetermined form. Representative examples of PSF forms suitable for the present embodiments include, without limitation, a double-helix PSF, star-shaped PSF, vortex PSF, Tetrapod PSF, or any PSF that encodes depth information in its shape. In experiments performed by the present inventors the passive optical system employed an optical mask which converted the PSF of set 14 into a double-helix PSF.

System 10 also comprises a digital light sensor 24. Preferably, sensor 24 is placed optically behind passive optical system 12. Optical field 18 passes through passive optical system 12, and is received by sensor 24, which converts the optical field into electrical signals. Sensor 24 is preferably a pixelated sensor, such as, but not limited to, a CCD or MOS or CMOS matrix, which provides a two-dimensional array of electrical signals forming a two-dimensional image.

System 10 is preferable monocular. The system is monocular in the sense that all the optical field collected that is collected by the system is sensed by the same digital light sensor 24, which provides a signal that describes a single perspective of scene 20.

Image sensor 24 can be a color sensor or a grey scale sensor. When sensor 24 is a color sensor, the image signal is typically, but not necessarily, resolved into at least three wavelength channels, by mean of a grid of color filters applied to the pixels of sensor 24, or by means of 3 or more separated pixilated imagers, each being overplayed by a filter of different color, or by any other polychromatic sensing technique.

When there are three or more wavelength channels, three wavelengths are optionally and preferably in the visible range, for example, a red channel, a green channel and a blue channel. Also contemplated are embodiments in which at least one of the wavelength channels is in the infrared range, and at least one of the wavelength channels is in the visible range. Also contemplated are embodiments in which at least one of the wavelength channels is in the ultraviolet range, and at least one of the wavelength channels is in the visible range. Also contemplated are embodiments in which at least one of the wavelength channels is in the infrared range, and at least one of the wavelength channels is in the ultraviolet range. Also contemplated are embodiments in which at least one of the wavelength channels is in the infrared range, at least one of the wavelength channels is in the visible range, and at least one of the wavelength channels is in the ultraviolet range. The present embodiments also contemplate a configuration in which the imager provides image signal resolved into four or more wavelength channels. For example, one of the four wavelength channels can be in the infrared range (e.g., near infrared range) and/or ultraviolet range (e.g., UVA, UVB, UVC range)) and each of the remaining three wavelength channels can be in the visible range.

A “visible range”, as used herein, refers to a range of wavelengths from about 400 nm to about 700 nm.

An “infrared range”, as used herein, refers to a range of wavelengths from about 700 nm to about 1 mm.

A “near infrared range”, as used herein, refers to a range of wavelengths from about 700 nm to about 1400 nm.

An “ultraviolet range”, as used herein, refers to a range of wavelengths from about 100 nm to about 400 nm.

A “UVA range”, as used herein, refers to a range of wavelengths from about 320 nm to about 400 nm.

A “UVB range”, as used herein, refers to a range of wavelengths from about 280 nm to about 320 nm.

A “UVC range”, as used herein, refers to a range of wavelengths from about 100 nm to about 280 nm.

A representative example of a set of wavelength channels suitable for the present embodiments is a red channel, corresponding to red light (e.g., light having a spectrum having an apex at a wavelength of about 580-680 nm), a green channel, corresponding to green light (spectrum having an apex at a wavelength of from about 500 to about 580 nm), and a blue channel, corresponding to blue light (spectrum having an apex at a wavelength of from about 420 to about 500 nm). Such a set of channels is referred to herein collectively as RGB channels.

Another representative example of a set of wavelength channels suitable for the present embodiments is a red channel, a green channel and a blue channel as detailed above, and also an infrared channel corresponding to near infrared light (spectrum having an apex at a wavelength of from about 800 to about 900 nm).

System 10 can comprise an image processor 26 having a circuit 28 configured to process the signals received from sensor 24 so as to decode the range information. This is optionally and preferably achieved by applying a transform, such as, but not limited to, a complex cepstrum transform, to the signal from the sensor 24. Alternatively, the range information can be decoded by other methods such as autocorrelation, or by employing machine learning procedure as further detailed hereinbelow. When a transform is employed, it contains a train of impulses of decreasing intensities, for any electrical signal that describes an echo of an object. When image sensor 24 provides a two-dimensional array of signals describing an echo of an object from scene 20, the transform contains one train of impulses, corresponding to a spatial translation of the echo in the image. The brightest impulses in a train of impulses of the transform thus correspond the lobes of the PSF, as varied by mask 16.

Based on the obtained transform, the range information can be decoded. This can be done in more than one way.

In some embodiments of the present invention image processor 26 uses the lobes described by the transform and decode the range information from a direction along which each lobe is orientated. For example, image processor 26 can calculate a center-of-mass of each lobe and calculate the lobe's orientation, relative of a predetermined point of reference (e.g., the image center). The inventors found that the orientation of the lobe correlates with the range to the object that provided the respective echo, allowing the range information to be decoded based on the calculated orientation.

Such an orientation-range correlation can be prepared in advance. The orientation-range correlation is typically specific to the mask 16 and is therefore prepared in advance after the type of mask 16 is selected. The preparation can be by conducting a set of experiments using objects, preferably point-like objects, at known distances from system 10, or, alternatively, by simulation, e.g., by means of ray-tracing software or the like.

The orientation-range correlation can be stored in a computer-readable memory 30 accessible by image processor 26, in the form of a look-up table, a graphical representation, a mathematical function, or the like. Thus, image processor 26 can access memory 30 and uses the stored correlation to convert the calculated orientation into a range. The range information provided by image processor 26 based on the stored correlation can include a range value for each of a plurality of objects in the scene.

In some embodiments of the present invention image processor 26 employs a machine learning procedure for decoding the range information. Preferably, the decoding by machine learning procedure is based on the obtained transform, but it may also be based on some preselected features that are extracted from the transform, e.g., lobes, impulses, etc. Also contemplated are embodiments in which the decoding by machine learning procedure is based on the image data contained in the signals provided by sensor 24.

As used herein the term “machine learning” refers to a procedure embodied as a computer program configured to induce patterns, regularities, or rules from previously collected data to develop an appropriate response to future data, or describe the data in some meaningful way.

Representative examples of machine learning procedures suitable for the present embodiments, include, without limitation, clustering, association rule algorithms, feature evaluation algorithms, subset selection algorithms, support vector machines, classification rules, cost-sensitive classifiers, vote algorithms, stacking algorithms, Bayesian networks, decision trees, neural networks (e.g., fully-connected neural network, convolutional neural network), instance-based algorithms, linear modeling algorithms, k-nearest neighbors (KNN) analysis, ensemble learning algorithms, probabilistic models, graphical models, logistic regression methods (including multinomial logistic regression methods), gradient ascent methods, singular value decomposition methods and principle component analysis.

Preferably, the machine learning procedure comprises an artificial neural network.

Artificial neural networks are a class of algorithms based on a concept of inter-connected “neurons.” In a typical neural network, neurons contain data values, each of which affects the value of a connected neuron according to connections with pre-defined strengths, and whether the sum of connections to each particular neuron meets a pre-defined threshold. By determining proper connection strengths and threshold values (a process also referred to as training), a neural network can decode the range information from the input information (for example, the image data itself or some transform, e.g., a complex cepstrum transform, thereof). Oftentimes, these neurons are grouped into layers in order to make connections between groups more obvious and to each computation of values. Each layer of the network may have differing numbers of neurons, and these may or may not be related to particular qualities of the input data.

In one implementation, called a fully-connected neural network, each of the neurons in a particular layer is connected to and provides input value to those in the next layer. These input values are then summed and this sum compared to a bias, or threshold. If the value exceeds the threshold for a particular neuron, that neuron then holds a positive value which can be used as input to neurons in the next layer of neurons. This computation continues through the various layers of the neural network, until it reaches a final layer. At this point, the output of the neural network procedure can be read from the values in the final layer. Unlike fully-connected neural networks, convolutional neural networks operate by associating an array of values with each neuron, rather than a single value. The transformation of a neuron value for the subsequent layer is generalized from multiplication to convolution. In various exemplary embodiments of the invention the machine learning procedure is a convolutional neural network (CNN).

The machine learning procedure used according to some embodiments of the present invention is a trained machine learning procedure, which provides output that is related non-linearly to the information with which it is fed.

A machine learning procedure can be trained according to some embodiments of the present invention by feeding a machine learning training program with the the image data itself or the obtained transform (or some preselected features that are extracted from the transform as further detailed hereinabove) and respective range data to objects at known distances to system 10. Once the data are fed, the machine learning training program generates a trained machine learning procedure which can then be used without the need to re-train it. The trained machine learning procedure can then be stored in computer-readable memory 30.

In use, image processor 26 accesses the trained machine learning procedure and feeds it with the image data described by the signals from sensor 24, or with a transform or preselected features of the transform after the transform has been applied to the signals from sensor 24. Image processor 26 can then receive from the trained machine learning procedure output that contains the range information. The range information can include a range value for each of a plurality of objects in the scene.

FIG. 10 is a flowchart diagram of a method suitable for measuring a range to an object (e.g., object 22) according to various exemplary embodiments of the present invention. It is to be understood that, unless otherwise defined, the operations described hereinbelow can be executed either contemporaneously or sequentially in many combinations or orders of execution. Specifically, the ordering of the flowchart diagrams is not to be considered as limiting. For example, two or more operations, appearing in the following description or in the flowchart diagrams in a particular order, can be executed in a different order (e.g., a reverse order) or substantially contemporaneously. Additionally, several operations described below are optional and may not be executed.

Some of the operations of the method can be implemented by one or more computer programs. Computer programs implementing the method can commonly be distributed to users on a distribution medium such as, but not limited to, a flash memory, CD-ROM, or a remote medium communicating with a local computer over the internet. From the distribution medium, the computer programs can be copied to a hard disk or a similar intermediate storage medium. The computer programs can be run by loading the computer instructions either from their distribution medium or their intermediate storage medium into the execution memory of the computer, configuring the computer to act in accordance with the method. All these operations are well-known to those skilled in the art of computer systems.

In various exemplary embodiments of the invention the method is implemented by system 10. The object can be a static object of a moving object (e.g., a vehicle).

The method begins at 40 and continues to 41 at which range information is encoded in an optical field arriving from the object. This can be done by means of a passive optical system (e.g., system 12) having a set of lenses (e.g., set 14) and an optical mask (e.g., mask 16) constituted to vary the PSF of the set of lenses, as further detailed hereinabove. The method proceeds to 42 at which image data of the object is captured by a digital light sensor (e.g., sensor 24) arranged to receive the optical field from the passive optical system, as further detailed hereinabove. The method continues to 43 the image data are processed to decode the range information, as further detailed hereinabove. The method ends at 44.

As used herein the term “about” refers to ±10% .

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Various embodiments and aspects of the present invention as delineated hereinabove and as claimed in the claims section below find experimental support in the following examples.

### EXAMPLES

Reference is now made to the following examples, which together with the above descriptions illustrate some embodiments of the invention in a non limiting fashion.

Standard imaging systems are designed for 2D representation of objects, while information about the third dimension remains implicit, as imaging-based distance estimation is a difficult challenge. Existing long-range distance estimation technologies mostly rely on active emission of signal, which as a subsystem, constitutes a significant portion of the complexity, size and cost of the active-ranging apparatus. Despite the appeal of alleviating the requirement for signal-emission, passive distance estimation methods are essentially nonexistent for ranges greater than a few hundreds of meters. This Example presents monocular long-range, telescope-based passive ranging, realized by integration of point-spread-function engineering into a telescope, extending the scale of point-spread-function engineering-based ranging to distances where it has never been tested before. This Example provides experimental demonstrations of the optical system in a variety of challenging imaging scenarios, including adversarial weather conditions, dynamic targets and scenes of diversified textures, at distances extending beyond 1.7 km. This Example also addresses the issue of the effect of atmospheric turbulence on estimation precision.

### Introduction

From microscopy to astronomy, depth estimation is a challenging task in optics due to difficulty of encoding three-dimensional (3D) information in a two-dimensional (2D) image. Spanning scales from nanometers to light-years, the requirement for depth estimation, namely, ranging, covers a variety of applications and has yielded numerous imaging schemes. At the scale of tens of meters to kilometers, ranging is especially essential in the fields of autonomous vehicles, defense, and aircraft landing systems. Most common techniques make use of active measurements. Such measurements, e.g. radar or LIDAR, rely upon detection of a signal returning from the ranged objects. The Inventers realized that this requires emission of intense signals, often making the measurement system bulky and expensive, or unsuitable for some applications due to safety or source-detectability constraints. Additionally, the Inventers realized that active ranging that is based on individual lines of sight (e.g. LIDAR) require scanning and may be rendered unreliable in the presence of even scarce amounts of dust particles in the air (1), due to back-scattering.

Passive ranging methods, on the other hand, benefit from relying solely on incoming optical signal. Traditional methods such as depth from focus/defocus(2), or triangulation by stereo imaging(3) are usually limited in their application to rather short distances. In fact, such methods have not been applied at distances far surpassing 100-200 meters(4), although efforts in this direction have been made(5). The Inventers realized that a limitation that is common to these methods stems from their dependence on highly accurate feature detection or blur estimation, which become inefficient at larger distances, where atmospheric turbulence (AT) comes into play. The Inventers realized that the focus/defocus approaches is that they require multiple frames under different camera settings, which usually involves mechanically moving parts. Stereo vision relies on two or more viewpoints(6), with challenges including the need for precise feature detection, as well as the bulkiness of an apparatus with two optical systems, and stringent cross-channel registration requirements. A different approach for ranging at such range scales makes use of signal degradation due to long propagation through the atmosphere—the effects of absorption, scattering and turbulence increase with distance, thus hold useful information(7, 8). The Inventers realized that due to unknown atmosphere properties, these methods require a priori information, such as the properties of the imaged scene, or the existence of a reference object at a known distance.

/Another approach for distance estimation is wavefront shaping, specifically, point-spread-function (PSF) engineering; it is implemented by modifying the light-path to the sensor in order to change the optical system's PSF(9-11), namely, the image that a point source generates in the detector plane. The modified PSF contains information on the curvature of the incoming wavefront, encoding the distance of the object. The versatility of the wavefront shaping approach lies in the ability to design the PSF per application—the PSF can capture distance for three-dimensional imaging(11-14), extend imaging DOF(15), encode color(16-19), correct aberrations(20, 21) and more.

This Example presents a monocular approach for long-distance ranging, based on PSF engineering in a telescope. Combining optical wavefront shaping with decoding algorithms enables us to demonstrate single-shot ranging of moving objects and real-world scenes at distances surpassing 1.7 km. This Example provides quantitative results obtained by analytical as well as deep neural-network based image analysis, and discuss the sources of error that bound system performance.

### Results

### Wavefront Shaping and Cepstrum Analysis

The optical system is based on a commercial telescope, augmented by a 4-f extension providing easy access to the Fourier plane. A diffractive optical element modulates the wavefront, consequently encoding depth information into the PSF (FIGS. 1A-D, also see Materials and Methods). In this Example, two depth-decoding techniques are explored for extraction of PSF information: a center-of-mass (CoM) based analytical approach and a neural-net based approach. The decoding method is inspired by previous related work by Berlich et al.(14), where the double-helix PSF(10, 22) was used to estimate distance at short ranges (˜1 m). With the double-helix PSF, the camera measures a convolution between a sharp image and the PSF comprising two lobes with orientation determined by the distance of the imaged object (FIGS. 1A-D). This image can be regarded to as one subject to an echo—a translated replica of the base signal. The decoding challenge is to recover the direction of the echo from the measured image, which entails the object distance. A useful mathematical tool to identify echoes in a signal is the complex cepstrum(23) (denoted from now on simply as cepstrum)— [symbol] , defined as:

[symbol]

(I)= [symbol] ⁻¹(ln( [symbol] (I))) (1)

where I is an image, [symbol] is the Fourier-transform operator, and ln denotes the natural logarithm operator. Given an image containing a single echo of translation xₜ, the cepstrum would contain a train of impulses following the same direction as xₜ(24). Upon finding the direction of the impulses in the cepstrum, the distance of the object in the image can be resolved. In practice, typically only two lobes from the train are visible.

In the analytical approach, distance estimation is achieved by locating each lobe's center-of-mass, calculating lobe orientation and comparing with a distance-to-angle calibration curve. In the neural net-based decoding approach, a neural net is trained to receive the cepstrum and output object distance (see Materials and Methods for details).

Note that the cepstrum is affected by scene content; this can be understood by examining two extreme cases—the first is an object containing no features at all—e.g. a plain wall or clear sky. Any modification to the PSF of such a scene would introduce no change to the measured image, thus so that no impulses in the cepstrum are observed in this case. The second extreme case is a signal that contains repetitive features in a distinct direction, such as a fence or window shutters. Such features in the image appear as an echo which will dominate the PSF-related impulse and could lead to incorrect distance estimation.

### Dynamic Object Distance Estimation

To demonstrate the applicability of the present embodiments to range determination from a moving object, the Inventors imaged a car driving along a straight road extending ˜800 m. Per frame, an ROI confined within the car boundaries was chosen. The ROI size was chosen to be 247^{∧}2 pixels, based on the apparent size of the car at its farthest position from the camera. Cepstrum analysis performed on larger ROIs reduces noise and leads to improved precision. A calibration function relating cepstrum lobe-angle, which is the PSF angle, to distance, was generated prior to the acquisition.

The calibration was made in a Field-of-View (FOV) dependent manner (see Materials and Methods for detailed calibration procedure), to account for a minor effect of FOV-dependence of the PSF which was observed. This effect may originate from the telescope lens, as the viewing angles are pushed farther than the design FOV of the telescope. Using the calibration, the PSF angle of an ROI inside the car was used to estimate the distance of the car per frame, using both the analytical CoM method and the neural-net method. As a validation, the Ground Truth (GT) distance of the car per frame was evaluated by application of prior knowledge, namely, by knowing the “track width” of the car (defined as the distance between the back wheels of the car) and that it smoothly moves away from the observer. Using the track width, the apparent magnification was calculated per frame, from which distance was derived.

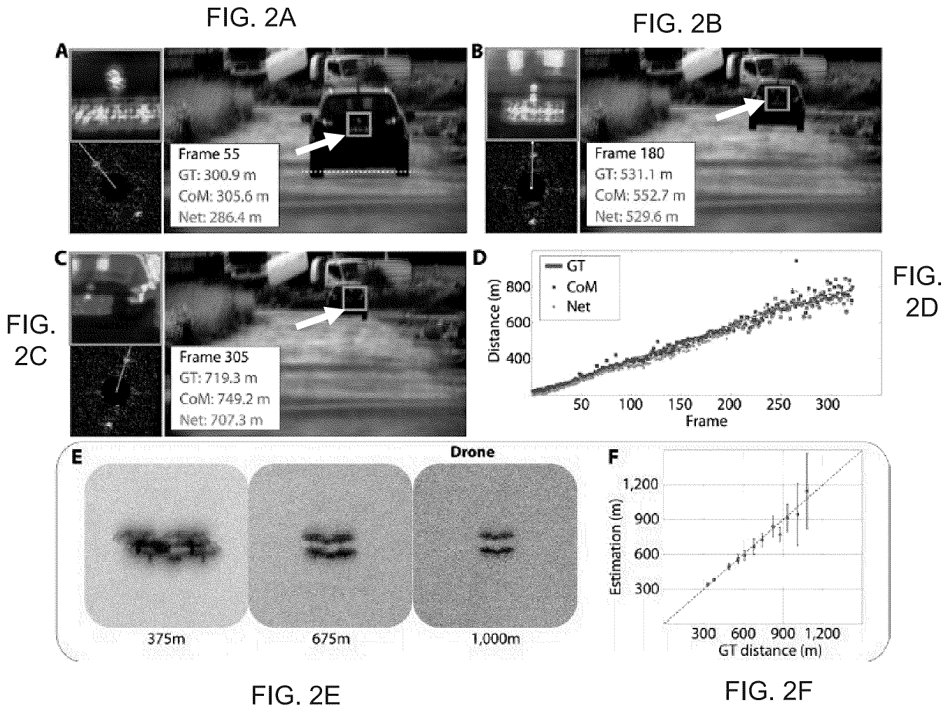

The results in FIGS. 2A-F show that the passive-ranging estimation complies with the GT, while the absolute error increases with distance. Throughout the motion, the single-shot error (deviation from GT) was calculated; average error was found to be 5.1% of GT for the CoM analysis, and 4.4% for the net, and remains typically below 10% for the duration of the motion. Nevertheless, two trends in the error are observed (FIG. 2D). The first is the decrease in precision with increasing distance. This is due to the reduced sensitivity of wavefront curvature to distance, and plausibly due to an increased contribution of AT as light travels a larger distance through the air. The second observable effect is finite accuracy, manifested as a bias (different slope) between the trend lines of estimated distances, in either of the analysis approaches, and the GT curve. This originates from finite mechanical stability of parts in the system (e.g. a PLA 3D-printed connection between the optics and the telescope frame), leading to small variations in system calibration when transported between experiment sites. Error that originates from bias is not native to the method, suggesting performance can improve upon using robust, e.g., metallic, components.

This Example also demonstrates dynamic aerial object ranging, by measuring the distance to a drone (DJI Mavic Mini), at several distances up to 1.08 km. Per distance, 100 frames were acquired. At large distances, the object was smaller than the PSF lobes separation, thus it appeared as two objects, shifted at the PSF angle corresponding the distance. By employing the cepstrum approach the PSF angles and the distances were extracted.

### Static Object Distance Estimation

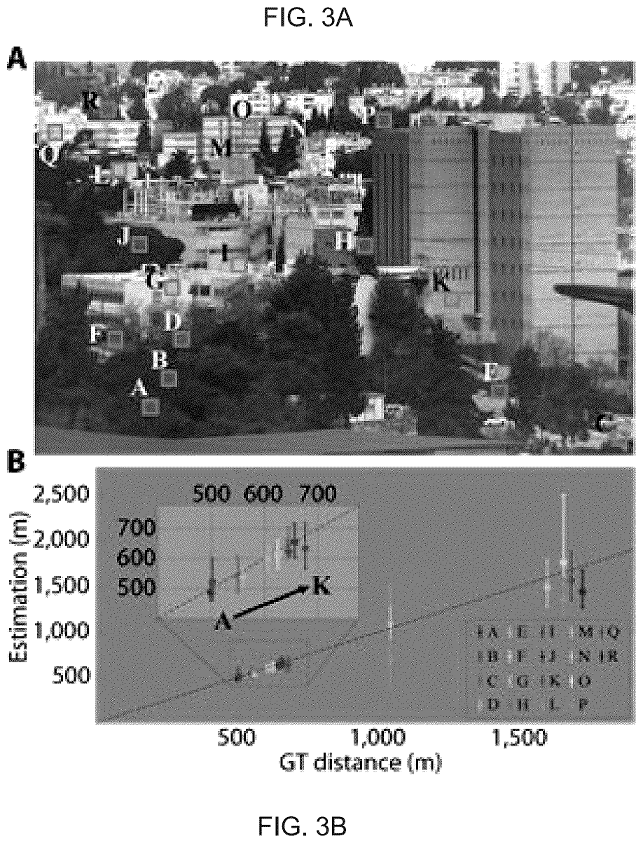

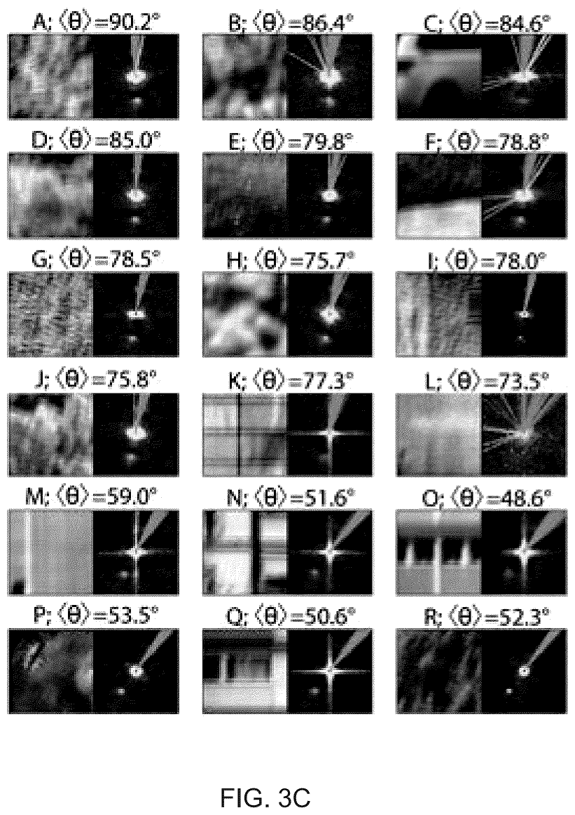

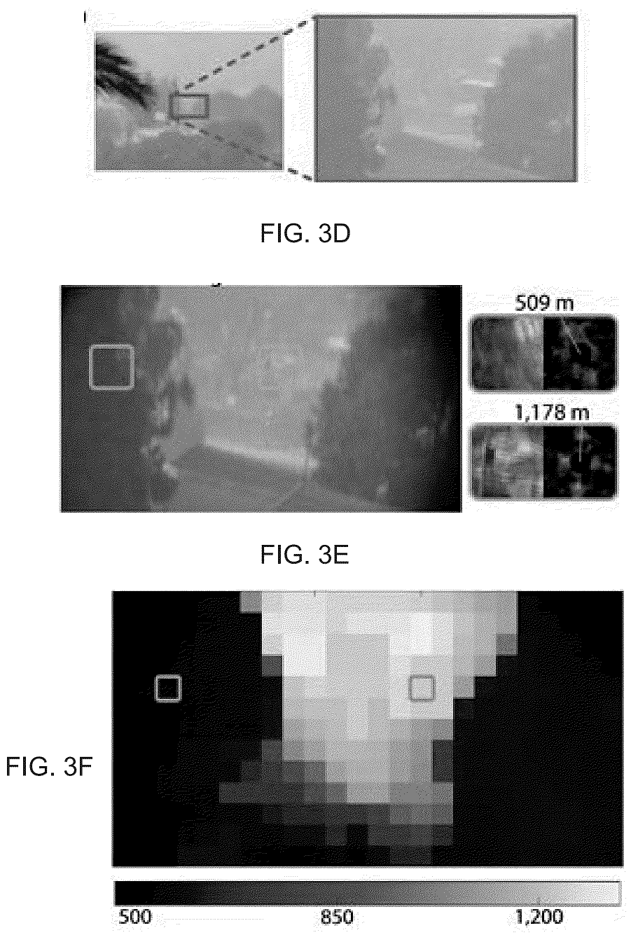

Another use of the present embodiments is passive, single-shot ranging of static objects. To demonstrate this application, the Inventors acquired images centered on 27 different objects (e.g. trees, walls, cars) spread across a large view (FIG. 3A). Per object, 100 frames were acquired, for the purpose of precision analysis. For objects closer than 1000 m, the GT distance was measured using a laser rangefinder (Sig Sauer KILO2200BDX). Beyond this applicable range of the laser rangefinder, GPS was used for distance determination. The precision of the rangefinder is estimated to be about 1 m, based on a discretization behavior it exhibited, and the precision of the GPS-based determination method to be 5 m. Exposure times were determined per frame to maximize image contrast while avoiding saturation (Table 1). Per frame, the cepstrum was calculated from an ROI of size 401^{∧}2 pixels, and the orientation of the PSF was extracted. A small subset of scenes (every 3^{rd} scene by order of acquisition) was used for calibration, while the other scenes were assigned as test data.

To improve the calibration process, the effect of unknown scene features over the cepstrum was reduced before lobe-determination. This was done by measuring in parallel an unmodulated, focused image, calculating the average cepstrum of 10 such frames, and subtracting it from the calibration cepstrums. Note that this parallel acquisition was performed only during the calibration step; all subsequent range estimations were done using a single modulated image. Additionally, cepstrums in the calibration data were averaged (in non-consecutive groups of 5) to improve the contrast before finding the lobe-angles. A calibration function was then fitted, relating lobe-angle to GT distance, which was eventually used for distance estimation.

The results of the 18 scenes comprising the test data are presented in FIGS. 3A-F and Table 1, below. It is observed that the lobes in the cepstrum remain visible regardless of distance, and are largely affected by the texture of the scene. The precision of the estimation is reduced as distance increases, mostly due to the decreased sensitivity of the wavefront curvature to distance. Bias was observed in several objects—primarily due to the contribution of the object features to the cepstrum, which may “pull” the lobes CoM in some direction. The effect is most significant in images that contain repetitive features or continuous lines, such as tiled walls or windows. Generally, if there is a repeating feature in a scene (or a continuous line), where the repetition angle is close to the direction of the PSF orientation, it will bias the CoM localization, affecting the estimated lobe angle. This can be observed in scene K, where a vertical line in the scene overshadows the near-vertical orientation of the ceptrum lobes. In other cases, the cepstral contribution of lines can be ignored if it is sufficiently separated from the PSF-induced lobes in the cepstrum (e.g. scenes M, Q).

Continuous lines in the image yield lines that cross the center of the cepsctum and reduce in intensity as the radius increases. Appearance of such line is not uncommon in urban scenes, and these cases were addressed algorithmically to only detect the lobes (see Materials and Methods). The results show consistency of the angle-distance relation which is maintained over a large range. The precision of the results, calculated from the standard deviation of the angle estimations, is given by the error bars in FIG. 3B. Another interesting scene is L, containing a concrete wall with essentially no features. This is an extreme example demonstrating the limitation of PSF engineering for ranging of objects with little-or-no texture, as hardly any features are seen in the cepstrum.

An advantage of the present embodiments over active range-finding is robustness to back-scatter from nearby scatterers, e.g. dust particles. To validate this, the performance of the system was examined under severe presence of dust in the air. Images of a scene spanning a broad range of distances were acquired, and the depth-map of the scene was analyzed. This was done by analyzing partially-overlapping ROIs (ROI size of 401^{∧}2 pixels, shift between adjacent ROI centers is 125 pixels). To account for the poor contrast from the dust, cepstrums from 5 consecutive frames were averaged before lobe-finding. Once found, the PSF angles were translated to distance using a calibration curve. Lastly, a median filter was applied to eliminate outliers, and obtain a depth-map of the scene (FIG. 3F). Under such a heavy presence of dust in the air, the laser rangefinder failed to measure any target farther than the tree to the left (reading 458 m), repeatedly returning values of 20-30 m. Similar results showing robustness to dust were obtained imaging a driving truck.

### Atmospheric Turbulence and Precision

Fluctuations in temperature and pressure of the air, namely, AT, induce random changes to the refractive index of the medium, distorting the wavefront. The effect of AT is clearly visible in long-distance (generally >100 m) imaging, both in traditional in-focus imaging and in the PSF-engineered setup. In traditional imaging, the contribution of AT is local translations across the image, accompanied by a blur due to the degraded PSF (Video S5). In the optical setup, the degraded wavefront (thus PSF) may also lead to false distance estimation.

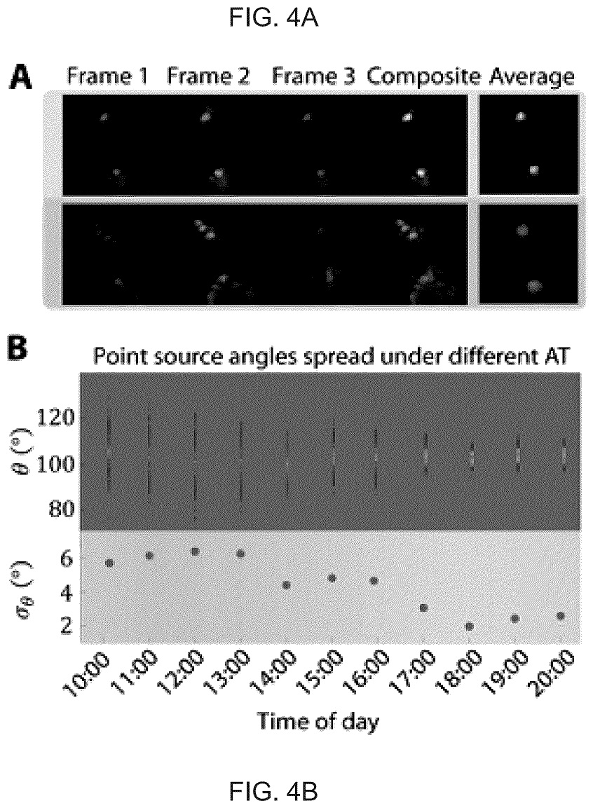

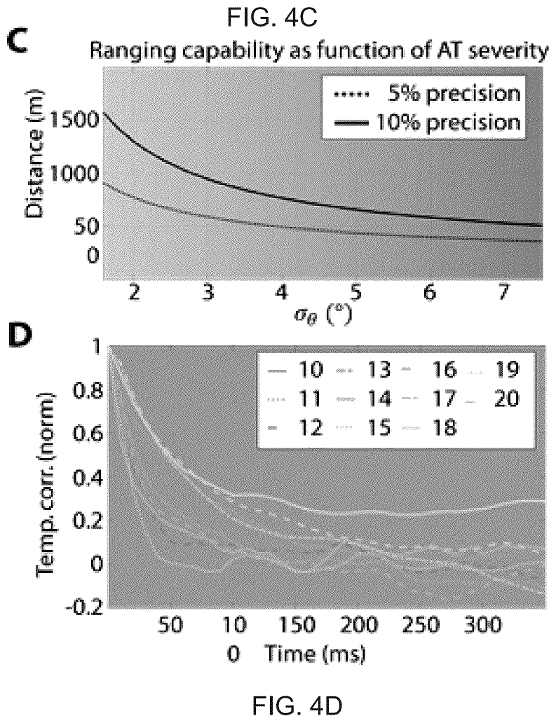

It is assumed that the main contribution to distance estimation error due to AT occurs by a wavefront curvature aberration (defocus)—other aberrations deform the lobes, introducing noise by lowering contrast. In order to evaluate the effect of turbulence on distance estimation, a point light source was imaged from a distance of 670 m. The acquisition was made on a hot day, where the peak turbulence was expected to be severe. Each hour, 1,000 frames were acquired under multiple exposure and gain settings, and in each frame the angle of the PSF was calculated by the CoM position of each of the PSF lobes. The effect of AT is apparent when imaging such a solitary point source, scintillating due to turbulence (FIG. 4A).

At around noon, where AT is at its peak, the effect on the angles was eminent. This can be seen by the increased spread of the PSF angles, reaching a standard deviation of PSF angles (σ_{θ}) of almost 6.5° (FIG. 4B). As AT-based error can be characterized by σ_{θ}, it can be translated to precision in distance estimation using the system calibration. FIG. 4C shows the system's single-shot ranging capabilities, providing a given tolerance of ranging precision (5% or 10%). Distance-determination precision can be improved by repeating the estimation over multiple frames; however, it is important to note that sufficient time is required between frames to obtain independence between the measurements, due to the finite correlation time of AT. This effect was measured by calculating the temporal correlation of the error in the different levels of AT (FIG. 4D), and found that the temporal correlation is between 20-70 ms, defined as the point where normalized correlation decreases to 0.5. Importantly, as one could expect, strong turbulence tends to feature shorter correlation times. The implication is that under strong AT, snapshots acquired with short time separation will improve ranging precision more than the case of weak AT. This provides some amount of counter-effect to the limited precision. During measurements, no effect of exposure time or gain levels over the precision we was observed, reinforcing the assumption that in the acquisition regime, the AT is the main cause for error, rather than limited photon count.

### Discussion

This Example demonstrated passive ranging by a monocular apparatus, to distances exceeding a kilometer, by incorporating PSF engineering in a telescope. The system performs well even in presence of significant AT and under high-scattering conditions, showing the promise of the approach. This Example presented and addressed the two most significant challenges of the method, which are 1) dependence of distance estimation quality on object features and 2) degradation due to AT. Regarding the former—fortunately, objects containing cepstrum-misleading patterns are rare to find in typical real-world scenes. This is especially true for dynamic objects (cars, planes, people, animals), which are often the target for ranging applications. The second challenge was AT. AT can be viewed as a source of noise to the wavefront, which would degrade any passive ranging approach. Nevertheless, the results show that even under severe turbulence, good estimation precision (<5%) can be maintained at distances of several hundreds of meters. Clearly, under low turbulence conditions, the precision improves significantly, and in any case it can be improved further by employing multi-frame analysis. Turbulence may be a reason of the lack of passive rangers at long distances, as it precludes achieving the pixel-level accuracy often highly necessary for such instruments(2). The current thorough demonstration of the method's validity holds the potential for a variety of technological extensions and applications.

Some embodiments of the present invention contemplate use of stronger materials and/or having a large phase-mask placed in front of the aperture. This is advantageous since it reduces the bias in the dynamic scene that is shown in FIG. 2D. Recent developments in diffractive optical element fabrication already enable simple custom-made phase masks on large scales, based on micron-scale 3D printing (25). The use of a large mask at the objective lens provides better flexibility in choice of magnification (thus FOV).

In data analysis, two approaches were exemplified: an algorithmic approach based on simple CoM analysis, and a neural network that was trained to handle cepstrums. Also contemplated are embodiments which incorporate object (feature) detection, prior assumptions, usage of temporal information, Kalman filtering (for moving objects) and more. Also, one of the main advantages of PSF engineering is the flexibility in designing the system's PSF. The analysis pipeline can improve results significantly by incorporating an initial optimal PSF-designing step (26). The PSF can feature improved compatibility to certain objects of interest (e.g. in an urban surrounding containing horizontal and vertical lines, the PSF may benefit from extending in the diagonal directions), or increased robustness to AT(27).

Here, PSF engineering was demonstrated by extending the optical path by a 4-f addition. A different way this can be done is by placing the phase mask directly on the lens (or in high proximity to it). Besides compactness, the new design reduces the number of optical elements in the system, which reduces aberrations and FOV-dependence of the whole system. The main challenge in implementing such a design is the need for a large mask, at the size of the aperture of the objective lens. Traditional nanofabrication methods (e.g. photolithography) which are designed for sub-micron resolution, are not optimal for fabrication over such a large area. A phase-mask fabrication method that relies on 3D printing (28), can be employed. This method requires the spatial resolution of the element fabrication to be 2-3 orders of magnitude larger than the traditional methods, allowing fabrication of larger masks than possible with nanofabrication at a significantly lower cost.

### Learned Phase Mask

A learned PSF can be used for optimal distance estimation. This approach is different to the experimental results shown in this Example. The PSF in this Example was designed to enable a simple, analytical analysis for a general ROI. A learned PSF can provide superior results without relying on an analytical estimation procedure. The 2nd improvement had already been employed in (26, 29). Such an approach increases precision, robustness to turbulence and reduce computation time during image analysis.

### Materials and Methods

### Optical System

This Example implements a PSF-engineering optical system comprising a telescope objective lens and a 4-f extension, to access the Fourier plane, where a diffractive optical element modulates the wavefront. A large light-gathering area is essential in order to maximize the information carried by the wavefront, thus an off-the-shelf telescope (Astromaster 102AZ, aperture diameter: 102 mm, f=660 mm) was used as the objective lens. The eyepiece module was removed and an optical 4-f extension was placed instead, held onto the telescope by a custom-made 3D printed mount. In the 4-f extension, a pair of CCTV lenses (Kowa LM50FC24M, f=50 mm) were used, which were found to be better than standard achromatic lenses from the standpoint of FOV dependent aberration, which may appear to be Petzval field curvature. In the Fourier plane of the extension, a photolithography-etched phase mask was placed. Additionally, a spectral bandpass filter (Chroma AT565/30) was placed to optimize PSF engineering performance. Images were captured by FLIR grasshopper 3 camera (GS3-U3-120S6M-C).

### Phase Mask Design

The phase mask of choice was inspired by previous work by Berlich et al.(14), where the double-helix PSF(10) was used to estimate distance in a macroscale scene. The mask was designed by implementing Vectorial-Implementation of Phase Retrieval(30) on a synthetic set of PSFs, featuring two lobes with revolving angle inversely proportional to distance. The quartz phase mask was fabricated by photolithography, as described previously(19, 26).

### Image Processing

### Complex Cepstrum—CoM-Based Analysis

The cepstrum domain is degraded due to the unknown object feature content, imaging noise and the shape of the PSF, which comprise of two lobes, rather than a pair of highly localized impulses. This required us to perform a series of steps in order to accurately allocate the impulses in the cepstrum, as shown in FIG. 1C. The process of obtaining the lobe-angles is as follows: Initially, apodization was applied in the ROI prior to cepstrum calculation, by multiplying the ROI by a Hann windowing function. This is done to reduce artificial vertical and horizontal lines to the cepstrum, which are desired to avoid.

Next, the cepstrum was calculated according to Eq. 1. Cepstrums from multiple images were then averaged, if needed (e.g. for system calibration). At this point, the cepstrum generally comprises of the two lobes, plus lines that intersect the center, in cases where continuous lines appear in the raw image. The goal is to find a proper window around one of the lobes, and to perform a CoM localization inside it. To avoid the center-intersecting lines, the cepstrums were multiplied by a weight matrix W, that enhances regions that have strong gradients in the radial direction, while oppressing regions of strong tangential gradients. To generate W, the cepstrum is blurred (Gaussian filtering with a σ=2 for all analysis except drone, for which a σ=3) and the gradients (both magnitude, Gₘ and direction, G_{φ}) are calculated. Gₘ is smoothed by a median filter, and the projection of the gradient on the radial direction is raised to a high power (we used 4), to obtain a weight function:

Wₚ(p, φ)=cos (φ−G_{φ}(p, φ))⁴,

where (p, φ) are the radial and angular polar coordinates of the matrix, Wₚ is a weight matrix based on the gradients' radial projection. The motivation for using Wₚ is to suppress regions where intense gradients appear that are mainly tangential, as in the case of the center-intersecting lines. The final weight matrix is obtained by multiplying the gradient magnitude matrix Gₘ by Wₚ, to maintain regions containing strong gradients in the radial direction, and applying a Gaussian blur. Once W is generated, it multiplies the original cepstrum (element-wise), and the product is blurred. In the result, the maximal pixel (x₀, y₀) contained inside a ring representing the lobe distance from the center is chosen as the center of the window. The ring is defined to be 6 pixels wide around the expected distance of the lobe, which is constant for all distances as determined by the PSF. For CoM calculation, the original cepstrum is smoothed by a median filter, then a window about (x₀, y₀) is cropped. Inside it, a threshold is applied to reduce the sensitivity of the localization to choice of window position(31). Finally, the CoM is calculated inside the window, leading to a value of θ—the angle where the lobe is centered; if the CoM is more than 1 pixel away from the center, the window center is updated according to the result and the CoM is calculated in the new window.

### Neural Network

A convolutional neural network was applied to decode distance from the cepstrum. The network was trained using cepstrums of simulated data, generated by convolving sharp telescope images with PSFs from the revised imaging model. The revision is done by performing phase retrieval(32) (specifically, Misell algorithm(33)) over measured PSFs of point sources at 12 known distances. 100 frames were acquired per distance in low turbulence conditions. The phase retrieval was implemented between the back focal plane and the image plane of the 4-f system. The phase mask was initialize as the designed one and iteratively update it by randomly choosing one frame per distance as the intensity constraint in the image plane.

The neural net includes a feature extraction part and a regression part. The former is used to obtain higher-level features of the input cepstrum, e.g. lobe positions. It consists of 4 convolution blocks/layers, each of which is made up of three consecutive convolution operations followed by batch normalization and ReLU nonlinear operation, and a max pooling at the end. The outputs of those 4 blocks have channel number of 32, 64, 128 and 256 respectively. Then a global pooling is applied to reduce both the height and width to 1. The regression part is a fully connected layer with Sigmoid as the activation function aiming to predict distance from the higher-level features. The relative Ll norm was applied as the loss function:

$$Loss = \frac{1}{N} {\sum }_{i = 1}^{N} \frac{\vert \hat{{y}_{ι}} - {y}_{i} \vert}{{y}_{i} + ϵ} ,$$

where [symbol] , yᵢ, and N are the network prediction, ground truth, and batch size (128), respectively, and and ∈=1 is a regularization constant.

### Data Acquisition

All data were acquired near the Technion and city of Haifa, Israel.
Car: Data were acquired at 16:00. Temperatures were around 17.5° C. and winds of around 10 km/h. Exposure time was 120 ms to account for low light conditions, as the car was driving west on sunset, with 200 ms between frames.
Drone: Data were acquired near Haifa in the morning. The weather was hot (˜31° C.) with moderate winds (˜13 km/h). Exposure times were between 6.5 ms to 11 ms, depending on the sky brightness due to clouds. Viewed from the front, the size of the drone is 31.8×26.7 cm^{∧}2. Outliers were excluded using mean absolute deviation (Matlab isoutlier function default), no more than 10 outliers were excluded per distance.
Static scenes—clear day: Data were acquired at noon. Temperatures were around 12° C. with wind of 18 km/h. Exposure times were determined by object brightness (albedo and illumination). Exact values are specified in Table 1, below. Outliers were excluded using mean absolute deviation, and are shown in FIG. 3C.
Static scene—dusty weather: Data was acquired at the afternoon. Temperature was 21.7° C. with low winds (<5 km/h). Exposure time was 60 ms, with gain of 5 dB.
Turbulence measurements: Data were acquired at time intervals of approximately one hour, from 10:00 to 20:00. The weather that day measured temperatures between 18.7-34° C. with wind speeds peaking at 34 km/h.

### System Calibration

### Cepstrum Angle-Distance Curve Fitting

Calibration was done by imaging a set of scenes containing objects having a well-known distance across the sensor (e.g. large walls with a planar depth map). For calibration, a large number of frames was acquired per scene. Each scene was divided to a grid of partially overlapping ROIs, with a single GT distance assigned to each ROI. Next, cepstrums were calculated per ROI, per frame, and then averaged in non-consecutive groups of 5 to improve the contrast prior to the lobe seeking. After obtaining the mean PSF-angle per ROI in each of the scenes, a calibration between angle and distance was fitted using the ROI lobe-angles and GT distances (see next paragraphs). Three fitted parameters per ROI determine the relation between PSF-angle and distance, locally. As a final step, 2n d degree 2D polynomials were fitted to each of the parameters across the FOV, to generate FOV-dependent calibration curves.

The relation between the PSF-angles in the cepstrum and distance, per ROI, was established experimentally by fitting local curves following the theoretical relation between these entities. This relation is based on the conjunction that the angle of the PSF is inversely proportional to the distance, according to the phase-mask design.

This conjunction leads to a generalized relation between the angle θ and distance z,

$$θ = a + \frac{b}{z - c} , \qquad ( 2 )$$

where α, b, c are the fit parameters. α represents the lobe angle at z→∞, b defines the sensitivity of the angle to change in distance and c is the distance corresponding the asymptote θ→∞. Rewriting for z one obtains:

$$z = c + \frac{b}{θ - a} \qquad ( 3 )$$

### Imaging Model and Phase Retrieval

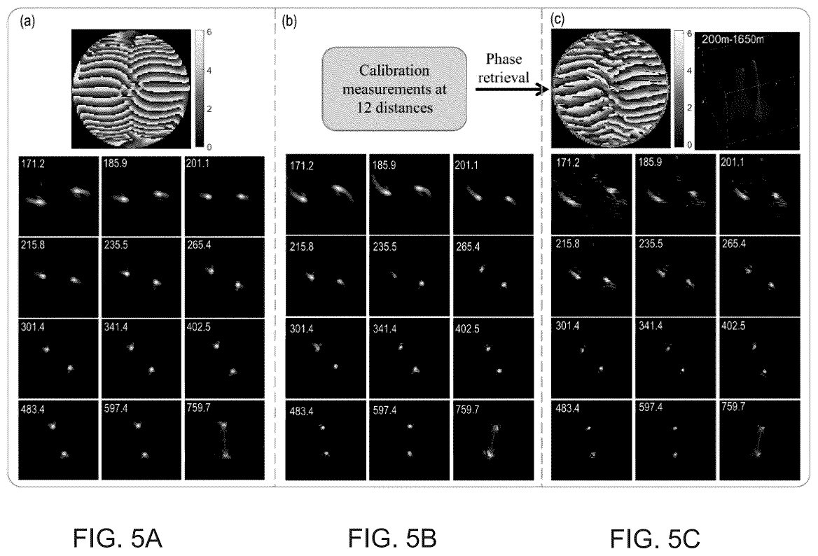

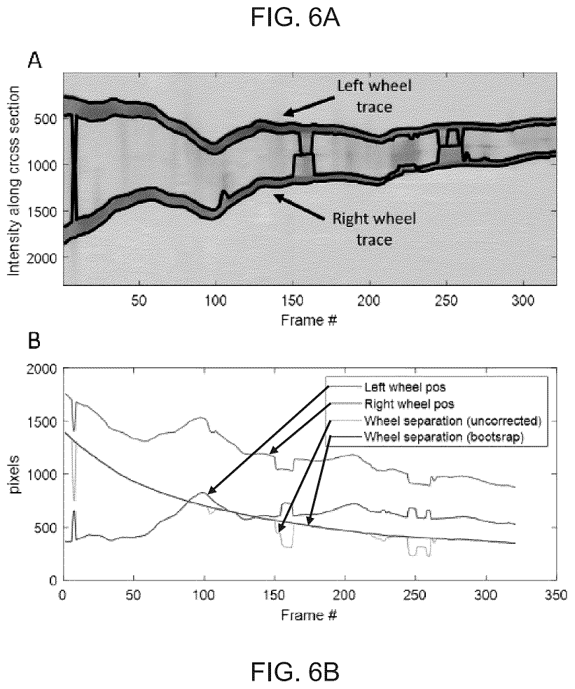

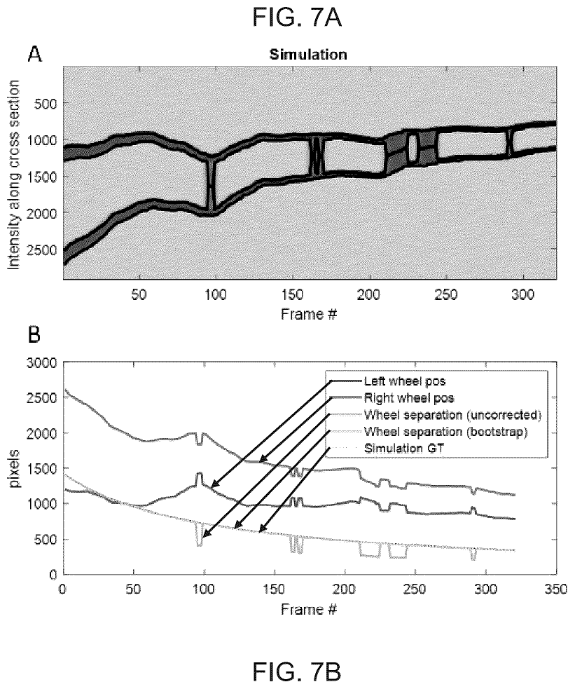

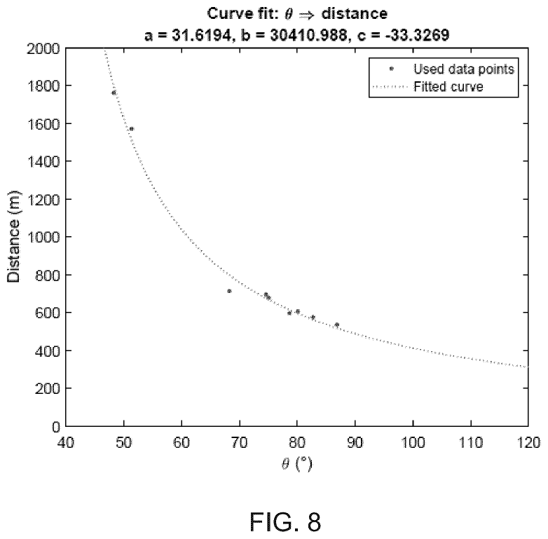

The image produced by the telescope is the convolution between the PSF and the object. For a point source, the light propagates through the telescope lens and reaches the entrance plane of the 4-f system, P1 , which, for long distance imaging, is slightly farther than the focal length after the objective lens. The electric field at this plane can be calculated according to [J. W. Goodman, Introduction to Fourier Optics (New York: W.H. Freeman, Macmillan Learning, 2017]:

$$h ( u , v ) = \frac{1}{{λ}^{2} {z}_{1} {z}_{2}} {e}^{j \frac{k}{2 {z}_{2}} ( {u}^{2} + {v}^{2} )} \int \int P ( x , y ) {e}^{j \frac{k}{2} ( \frac{1}{{z}_{1}} + \frac{1}{{z}_{2}} - \frac{1}{f} ) ( {x}^{2} + {y}^{2} )} \cdot {e}^{- j \frac{k}{{z}_{2}} ( ux + vy )} dxdy \qquad ( EQ . 1 )$$

where (u, v) denote coordinates in P1; λ, k and z₁ are wavelength, wave number and object distance, z₂ is the distance between the lens and P1, which is close to ƒ, the focal length. P(x, y) is the aperture function of objective where (x, y) denote the coordinates at the objective plane. PSF engineering is done by placing a diffractive optical element (DOE) at the pupil plane, i.e., back focal plane (BFP) of the 4-f system. The phase pattern of the DOF is shown in FIG. 5A, and was simulated with a pixel size of 78.19 μm. In simulation, proper sampling is the required to guarantee consistence with the physical imaging system. It is desired to obtain a simulation pixel size corresponding the camera pixel pitch. The relation between the sampling in the BFP and the image plane is given by EQ. 2,

$$\frac{λ {f}_{4 f}}{{δ}_{b}} = {δ}_{i} N \qquad ( EQ . 2 )$$

where δ_{b} and δᵢ denote the sampling spacing at the BFP and imaging plane respectively; ƒ4ƒ is the focal length of the 4-f system lenses and N is the simulated number of pixels. If we set δb as the designed DOE pixel size, N will be 104; however, simulation fails due to aliasing in this case, as Nyquist sampling is not obtained. This sampling spacing was halved to obtain simulation size of 209. With these settings, the simulated PSFs at different object distances is shown in FIG. 5A.

Note that there is deviation between simulated and experiment PSFs. FIG. 5B shows the average PSF of 100 frames at each distance. Comparing FIGS. 5A and 5B, one significant deviation is that the rotation rate of simulated PSFs, namely, angle vs. distance, is slower than that of experimental ones. At the largest distance 759.7 m, an obvious angle difference of the lobes in PSF can be seen. This may be caused by many factors, e.g. phase mask fabrication and alignment errors, or objective-induced aberrations. To account for these deviations, we apply the phase retrieval based on Misell iteration to revise the imaging model. Calculating the wavefront at P1, we further propagate it to the BFP by a Fourier transform. The iterative phase retrieval process is then implemented between the BFP and the final image plane where the intensity constraints are added. The iterative process was as follows:
1) Initialize the phase value of the mask at back focal plane as the designed one (FIG. 5A).
2) Using EQ. (1) and FFT, calculate the wavefront at the sensor plane corresponding the 1ₛₜ object distance.
3) Randomly choose one frame of PSF calibration measurement at the 1ₛₜ distance as the intensity constraint of the electric field from step 2.
4) Apply an inverse Fourier transform to calculate the BFP electric field and update the phase mask.
5) Repeat steps 2-4 using another distance for a set number of iterations.

With PSF constraints at 12 distances, the iteration converges quickly. The retrieved phase and revised simulated PSFs are shown in FIG. 5C. The revised lobe rotation speed is consistent with the experimental PSFs. The simulated PSF at the farthest distance has the same lobe angle as the experiment. The Inventors applied the revised imaging model to generate PSFs from 200 m to 1650 m and the 3D illustration is shown in FIG. 5C. The PSF rotation speed is decreasing with the increase of object distance, making lobe angle increasingly less sensitive to the distance change

### GT Evaluation—Car Analysis (See FIGS. 2A-F, Above)

To evaluate GT car distance from apparent wheel separation, the intensity along a line crossing through both wheels was analyzed per frame. For evaluation, the lines were transposed and concatenated, to form an image, where each column in the image corresponds to a section of a single frame. By applying a threshold, the two lines formed by the wheels (blue lines) were distinguished, as marked by thick black curves. In several frames, the region between the lines was darker due to a shadow cast by the car, which leads to a wrong wheel recognition by the threshold operation.

While the shadow causes the wheels to appear significantly closer in some frames, the smoothing was applied (based on resemblance to a 1/(frame number) trend, as expected by knowing the car maintains a constant speed), which well ignores the outliers. After excluding the outliers, the curve was smoothed (again, based on the car motion properties), and the result was converted to distance estimation based on magnification

The smooth constant-speed motion of the car satisfies a significant prior for GT estimation, and deflects the discussion from finite precision to accuracy of the GT estimation. Three factors may affect the accuracy: 1. Error in the magnification curve. 2. Error in the physical distance between the wheels (which results in erroneous magnification values). 3. Error in wheel distance estimate on process (e.g. due to shadows, PSF).

The magnification curve was generated using two small LEDs attached to a post, maintaining a fixed, known separation. The LEDs were imaged at 12 distances, measured with a rangefinder (at distances of 100 m-800 m). As the rangefinder precision is ˜1 m, the error contribution by it is negligible. Next, the image-plane separation between sources at the was determined to calculate the magnification. A curve of magnification (M) per distance (z) was then fitted, following the basic magnification formula M∝z⁻¹ (R²>0.999). The telescope had not mover between acquisition of the car and imaging the LEDs, so we believe an error in the magnification curve is negligible.

Regarding the 2nd, the manufacturer specs regarding the track width were examined, and the actual distance between the wheels were measured with a measuring tape. Nevertheless, the best precision that verified the value (1,500 mm) is 1%. An error in this value leads to an equivalent fractional error in distance estimation.

To evaluate the 3rd factor, the Inventors ran simulations of wheels convolved with various PSFs and added shadows to test for a bias in the wheel separation, which compromises accuracy. As expected, under the assumption that both wheels are the same distance from the observer (thus have the same PSF), the PSF does not lead to any bias. Also, as long as shadow-induces outliers are well excluded, no bias is added by the wheel-separation estimation. In addition, the final smoothing of the function imposed by the smooth nature of the car distancing from the observer strongly improves the accuracy of the curve.

In total, considering the 1% error in track-width estimation, and the two negligible but nonzero factors 1 and 3, we estimate a conservative upper bound of the GT accuracy at 1.5% of the true distance. This is still significantly below the precision of the method (3.5-6%), so it satisfies a good benchmark for performance evaluation.

TABLE 1
Results of distance estimations of static scenes (FIGS. 3A-F)

| | | | | Estimation | |
|---|---|---|---|---|---|
| | | GT | Mean | standard | Relative |
| | Exposure | distance | estimation | deviation | precision |
| Scene | (ms) | (m) | (m) | (m) | (%) |
| A | 54.2 | 501 | 486.8 | 25.3 | 5.2 |
| B | 16.2 | 502 | 529.9 | 69.0 | 13.0 |
| C | 11.2 | 550 | 546.6 | 60.2 | 11.0 |
| D | 31.7 | 559 | 537.9 | 31.4 | 5.8 |
| E | 20.3 | 606 | 600.3 | 38.7 | 6.4 |
| F | 13 | 624 | 615.0 | 47.6 | 7.7 |
| G | 27.3 | 627 | 617.7 | 43.7 | 7.1 |
| H | 16.2 | 645 | 659.9 | 46.7 | 7.1 |
| I | 9 | 645 | 623.0 | 21.0 | 3.4 |
| J | 46.4 | 656 | 659.1 | 55.4 | 8.4 |
| K | 11.2 | 677 | 641.6 | 80.2 | 12.5 |
| L | 29.7 | 1,037 | 913.9 | 533.0 | 58.3 |
| M | 18.9 | 1,040 | 1,100.1 | 167.3 | 15.2 |
| N | 9 | 1,593 | 1,528.6 | 269.7 | 17.6 |
| O | 12.1 | 1,650 | 1,945.7 | 717.2 | 36.9 |
| P | 54.2 | 1,650 | 1,389.1 | 226.0 | 16.3 |
| Q | 40.1 | 1,677 | 1,605.4 | 262.1 | 16.3 |
| R | 54.2 | 1,697 | 1,466.0 | 213.0 | 14.5 |

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

### REFERENCES

1. T. G. Phillips, N. Guenther, P. R. McAree, When the Dust Settles: The Four Behaviors of LiDAR in the Presence of Fine Airborne Particulates. J. F. Robot. 34, 985-1009 (2017).
2. Y. Y. Schechner, N. Kiryati, in Proceedings. Fourteenth International Conference on Pattern Recognition (Cat. No.98EX170) (IEEE Comput. Soc; http://ieeexplore(dot)ieee(dot)org/document/712074/), vol. 2, pp. 1784-1786.
3. A. OrRiordan, T. Newe, G. Dooly, D. Toal, in 2018 12th International Conference on Sensing Technology (ICST) (IEEE, 2018; https://ieeexplore(dot)ieee(dot)org/document/8603605/), pp. 178-184.
4. F. Blais, Review of 20 years of range sensor development. J. Electron. Imaging. 13, 231 (2004).
5. B. Vanek, A. Zarandy, A. Hiba, P. Bauer, T. Tsuchiya, S. Nagai, R. Mori, “Technical note D4 . 7 Preliminary validation results of vision-based navigation techniques” (2019).
6. A. Saxena, S. Jamie, A. Y. Ng, Depth estimation using monocular and stereo cues. IJCAI Int. Jt. Conf. Artif. Intell., 2197-2203 (2007).
7. S. G. Narasimhan, S. K. Nayar, Vision and the Atmosphere. Int. J. Comput. Vis. 48, 233-254 (2002).
8. C. Wu, J. Ko, J. Coffaro, D. A. Paulson, J. R. Rzasa, L. C. Andrews, R. L. Phillips, R. Crabbs, C. C. Davis, Using turbulence scintillation to assist object ranging from a single camera viewpoint. Appl. Opt. 57, 2177 (2018).
9. G. E. Johnson, E. R. Dowski, W. T. Cathey, Passive ranging through wave-front coding: information and application. Appl. Opt. 39, 1700 (2000).
10. A. Greengard, Y. Y. Schechner, R. Piestun, Depth from diffracted rotation. Opt. Lett. 31, 181 (2006).
11. Y. Shechtman, S. J. Sahl, A. S. Backer, W. E. Moerner, Optimal Point Spread Function Design for 3D Imaging. Phys. Rev. Lett. 113, 133902 (2014).
12. A. Levin, R. Fergus, F. Durand, W. T. Freeman, Image and depth from a conventional camera with a coded aperture. ACM Trans. Graph. 26, 70 (2007).
13. S. Quirin, R. Piestun, Depth estimation and image recovery using broadband, incoherent illumination with engineered point spread functions [Invited]. Appl. Opt. 52, A367 (2013).
14. R. Berlich, A. Bräuer, S. Stallinga, in Imaging and Applied Optics 2016 (OSA, Washington, D.C., 2016; https://www(dot)osapublishing (dot)org/abstract(dot)cfm?URI=COSI-2016-CTh1D(dot)4), p. CTh1D.4.
15. S. Tucker, W. T. Cathey, E. Dowski, Jr., Extended depth of field and aberration control for inexpensive digital microscope systems. Opt. Express. 4, 467 (1999).
16. J. Broeken, B. Rieger, S. Stallinga, Simultaneous measurement of position and color of single fluorescent emitters using diffractive optics. Opt. Lett. 39, 3352 (2014).
17. Y. Shechtman, L. E. Weiss, A. S. Backer, M. Y. Lee, W. E. Moerner, Multicolour localization microscopy by point-spread-function engineering. Nat. Photonics. 10, 590-594 (2016).
18. E. Hershko, L. E. Weiss, T. Michaeli, Y. Shechtman, Multicolor localization microscopy and point-spread-function engineering by deep learning. Opt. Express. 27, 6158 (2019).
19. N. Opatovski, Y. Shalev Ezra, L. E. Weiss, B. Ferdman, R. Orange-Kedem, Y. Shechtman, Multiplexed PSF Engineering for Three-Dimensional Multicolor Particle Tracking. Nano Lett. 21, 5888-5895 (2021).
20. V. Sitzmann, S. Diamond, Y. Peng, X. Dun, S. Boyd, W. Heidrich, F. Heide, G. Wetzstein, End-to-end optimization of optics and image processing for achromatic extended depth of field and super-resolution imaging. ACM Trans. Graph. 37, 1-13 (2018).
21. X. Dun, H. Ikoma, G. Wetzstein, Z. Wang, X. Cheng, Y. Peng, Learned rotationally symmetric diffractive achromat for full-spectrum computational imaging. Optica. 7, 913 (2020).
22. S. R. P. Pavani, R. Piestun, High-efficiency rotating point spread functions. Opt. Express. 16, 3484 (2008).
23. D. G. Childers, D. P. Skinner, R. C. Kemerait, The cepstrum: A guide to processing. Proc. IEEE. 65, 1428-1443 (1977).
24. J. K. Lee, M. Kabrisky, M. E. Oxley, S. K. Rogers, D. W. Ruck, The complex cepstrum applied to two-dimensional images. Pattern Recognit. 26, 1579-1592 (1993).
25. R. Orange-Kedem, E. Nehme, L. E. Weiss, B. Ferdman, O. Alalouf, N. Opatovski, Y. Shechtman, 3D printable diffractive optical elements by liquid immersion. Nat. Commun. (2021), doi:10.1038/s41467-021-23279-6.
26. E. Nehme, D. Freedman, R. Gordon, B. Ferdman, L. E. Weiss, O. Alalouf, T. Naor, R. Orange, T. Michaeli, Y. Shechtman, DeepSTORM3D: dense 3D localization microscopy and PSF design by deep learning. Nat. Methods. 17, 734-740 (2020).
27. X. Liu, J. Pu, Investigation on the scintillation reduction of elliptical vortex beams propagating in atmospheric turbulence. Opt. Express. 19, 26444 (2011).
28. R. Orange-Kedem, E. Nehme, L. E. Weiss, B. Ferdman, O. Alalouf, N. Opatovski, Y. Shechtman, 3D printable diffractive optical elements by liquid immersion. Nat. Commun. 2021 121. 12, 1-6 (2021).
29. E. Nehme, B. Ferdman, L. E. Weiss, T. Naor, D. Freedman, T. Michaeli, Y. Shechtman, Learning Optimal Wavefront Shaping for Multi-Channel Imaging. IEEE Trans. Pattern Anal. Mach. Intell. 43, 2179-2192 (2021).
30. B. Ferdman, E. Nehme, L. E. Weiss, R. Orange, O. Alalouf, Y. Shechtman, VIPR: vectorial implementation of phase retrieval for fast and accurate microscopic pixel-wise pupil estimation. Opt. Express. 28, 10179 (2020).
31. H. C. van Assen, M. Egmont-Petersen, J. H. C. Reiber, Accurate object localization in gray level images using the center of gravity measure: accuracy versus precision. IEEE Trans. Image Process. 11, 1379-1384 (2002).
32. J. R. Fienup, Reconstruction of an object from the modulus of its Fourier transform. Opt. Lett. Vol. 3, Issue 1, pp. 27-29. 3, 27-29 (1978).
33. Y. Xu, Q. Ye, A. Hoorfar, G. Meng, Extrapolative phase retrieval based on a hybrid of PhaseCut and alternating projection techniques. Opt. Lasers Eng. 121, 96-103 (2019).

What is claimed is:

1. A range imaging system, comprising:
a passive optical system having a set of lenses and an optical mask constituted to vary a point spread function (PSF) of said set of lenses so as to encode in an optical field arriving from a scene range information for objects in said scene that are at least X meters from said mask, X being at least 10;
a digital light sensor arranged to receive said optical field; and
an image processor, configured to processes signals receive signals from said sensor to decode said range information.

2. The system according to claim 1, wherein said set of lenses forms a 2-f optical arrangement, and said optical mask is at a back focal plane thereof.

3. The system according to claim 1, wherein said set of lenses forms a 2-f optical arrangement, and said optical mask is at a Fourier plane thereof.

4. The system according to claim 1, wherein said passive optical system is characterized by an aperture diameter of at least 50 mm.

5. The system according to claim 1, wherein said optical mask is configured to vary said PSF into a double-helix PSF.

6. The system according to claim 1, wherein said sensor is a thermography sensor.

7. The system according to claim 1, wherein said image processor is configured to apply a cepstrum transform to said signals.

8. The system according to claim 1, wherein said image processor is configured to calculate an orientation of a lobe of said varied PSF, wherein said decoding is based on said orientation.

9. The system according to claim 8, wherein said image processor is configured to calculate a center-of-mass of said lobe, wherein said calculation of said orientation is based on said center-of-mass.

10. The system according to claim 1, wherein said image processor is configured to decode said range information by applying machine learning.

11. The system according to claim 10, wherein said image processor is configured to apply a cepstrum transform to said signals and to feed said cepstrum transform into a machine learning procedure trained to output said range information.

12. The system according to claim 1, wherein said image processor is configured to apply an object recognition image processing to identify an object in said scene, wherein said decoding is executed for said identified object.

13. The system according to claim 1, wherein said optical mask is a phase mask.

14. The system according to claim 1, wherein said optical mask is an amplitude mask.

15. The system according to claim 1, wherein said optical mask is a phase-amplitude mask.

16. The system according to claim 1, wherein said optical mask is a 3D-printed optical mask.

17. A method of measuring a range to an object, comprising:
capturing image data of the object by digital light sensor arranged to receive an optical field from a passive optical system having a set of lenses and an optical mask constituted to vary a point spread function (PSF) of said set of lenses so as to encode in said optical field range information for ranges that are at least X meters from said mask, X being at least 10; and
processing said image data signals to decode said range information.

18. The method according to claim 17, wherein the object is static.

19. The method according to claim 17, wherein the object is a moving object.

20. The method according to claim 17, wherein the object is a vehicle.
